(19) United States
(12) Patent Application Publication
(10) Pub. No.: US 2002/0063227 A1
(43) Pub. Date: May 30, 2002

(54) Water level regulating valve

(76) Inventors: Nobuyuki Matsuura, Komaki-shi (JP); Hisayuki Yamaguchi, Komaki-shi (JP)

Correspondence Address: FLYNN, THIEL, BOUTELL & TANIS, P.C., 2026 Rambling Road, Kalamazoo, MI, 49008-1699, US

(21) Appl. No.: 09/891,113

(22) Filed: Jun. 25, 2001

(30) Foreign Application Priority Data
Nov. 27, 2000 (JP) 2000-358606

(51) Int. Cl. F16K 31/12

(52) U.S. Cl. 251/29

(57) ABSTRACT

A primary pressure chamber (7) and a secondary pressure chamber (8) leading to an inlet (5) disposed at the lower part of a main body and an outlet (6) disposed at a side part of the main body, respectively, are formed by dividing an interior of the main body, and the chambers (7, 8) are linked to each other through a valve port (10) upwardly formed coaxially with the inlet (5). A valve disc (11) disposed to open and close the valve port (10) is urged in a valve-closing direction by a spring (12). A diaphragm (13) coupled to the valve disc (11) divides a diaphragm chamber (15) disposed on a back side of the diaphragm (13) in the interior of the main body (1) from the primary pressure chamber (7) An effective pressure-receiving area of the diaphragm (13) on a side of the diaphragm chamber (15) is set greater than that of the diaphragm on a side of the primary pressure chamber (7). The chambers (7, 15) are linked to each other through a bypass flow path (22). The diaphragm chamber (15) is linked to a primary side of a ball tap (S). Accordingly, in a feedwater-stopped state, both the pressure-receiving surfaces of the diaphragm (13) are supported by the same pressure, and a load applied onto the diaphragm (13) can be reduced, and the possibility that the diaphragm (13) will be broken can be reduced.

### BACKGROUND OF THE INVENTION

1. Field of the Invention

This invention relates to a water level regulating valve provided to constitute a flow path between a water tank and a vertical water pipe disposed next to the water tank so that the flow path becomes perpendicular to both the water tank and the water pipe.

2. Description of the Related Art

A water level regulating valve constructed as shown in FIGS. 4 and 5 can be mentioned as a conventional type. The water level regulating valve a has an inlet b connected to a water pipe p at its lower part, an angle type valve box d that includes an outlet c connected to a water tank T at the side part of the water level regulating valve a, a bonnet e used as a lid that is joined to the valve box d, and a water level regulating mechanism f in the interior of the valve. In the valve mechanism f, a valve port i through which a primary pressure chamber g leading to the inlet b is linked to a secondary pressure chamber h leading to the outlet c is upwardly made coaxially with the inlet b, and a valve disc j for opening and closing the valve port i is disposed freely attachably/detachably, and is urged by a spring k in a direction in which the valve port i is closed. A diaphragm n is disposed above the valve disc j by means of a valve rod m, and is situated between the valve box d and the bonnet e disposed on the upper part of the valve box d. A space enclosed by the diaphragm n and the bonnet e is defined as a diaphragm chamber p, and the diaphragm chamber p and the secondary pressure chamber h are divided by the diaphragm n. The diaphragm chamber p and the primary pressure chamber g lead to the primary side of a ball tap S serving as a pilot valve disposed on the water tank T through a branch pipe g. When the water level regulating valve a is in a feedwater-stopped state, the valve disc j is closed by the primary pressure acting on the interior of the diaphragm chamber p and by the elastic force of the spring k in a valve-closing direction through the valve rod m. When the water level of the water tank T falls and thereby the ball tap S opens, the internal pressure of the diaphragm chamber p becomes lower than that of the primary pressure chamber g, and, as a result, the internal pressure of the primary pressure chamber g opens the valve disc j against the elastic force of the spring k so as to supply water to the water tank T.

However, in the feedwater-stopped state of the water level regulating valve a constructed as above, the diaphragm n is moved in the valve-closing direction (i.e., downwardly) by the primary pressure acting on the diaphragm chamber p, in other words, pressure is applied only onto the one side of the diaphragm n (i.e., onto the side of the diaphragm chamber p), and therefore the valve will be easily broken unless its rigidity is strengthened. For this reason, the diaphragm n to be used must be thick in the water level regulating valve a. However, such a thick diaphragm n cannot be expected to operate flexibly, and causes a hindrance to the opening and closing of the valve disc so as to prevent the normal functioning of the regulating valve. In order to remove this defect, the receiving pressure diameter of the diaphragm n must be extremely enlarged. However, this is a disadvantage in that the water level regulating valve a becomes large in size.

### SUMMARY OF THE INVENTION

In order to resolve the problem, a water level regulating valve of the present invention is characterized in that an inlet is disposed at the lower part of a main body, an outlet is disposed at a side part of the main body, a primary pressure chamber and a secondary pressure chamber formed by dividing an interior of the main body so as to lead to the inlet and the outlet, respectively, are linked to each other through a valve port upwardly formed coaxially with the inlet, a valve disc disposed to open and close the valve port is urged in a valve-closing direction by a spring, a diaphragm chamber disposed on a back side of the diaphragm in the interior of the main body and the primary pressure chamber are divided by a diaphragm coupled to the valve disc, an effective pressure-receiving area of the diaphragm on a side of the diaphragm chamber is set greater than an effective pressure-receiving area of the diaphragm on a side of the primary pressure chamber, the primary pressure chamber and the diaphragm chamber are linked to each other through a bypass flow path, the diaphragm chamber is linked to a primary side of a ball tap serving as a pilot valve. Accordingly, in a feedwater-stopped state of the water level regulating valve, primary pressure is applied onto the primary pressure chamber and the diaphragm chamber divided by the diaphragm, i.e., the same pressure is applied onto both pressure receiving surfaces of the diaphragm so as to reduce a load applied onto the diaphragm itself, and the valve disc is closed by valve-closing force resulting from a difference in received pressure caused by the fact that the side of the diaphragm chamber is larger than the side of the primary pressure chamber in the effective pressure-receiving area of the diaphragm and by elastic force of the spring in the valve-closing direction.

### BRIEF DESCRIPTION OF THE DRAWINGS

FIG. 1 shows a water level regulating valve in use.

FIG. 2 is a sectional view of the water level regulating valve.

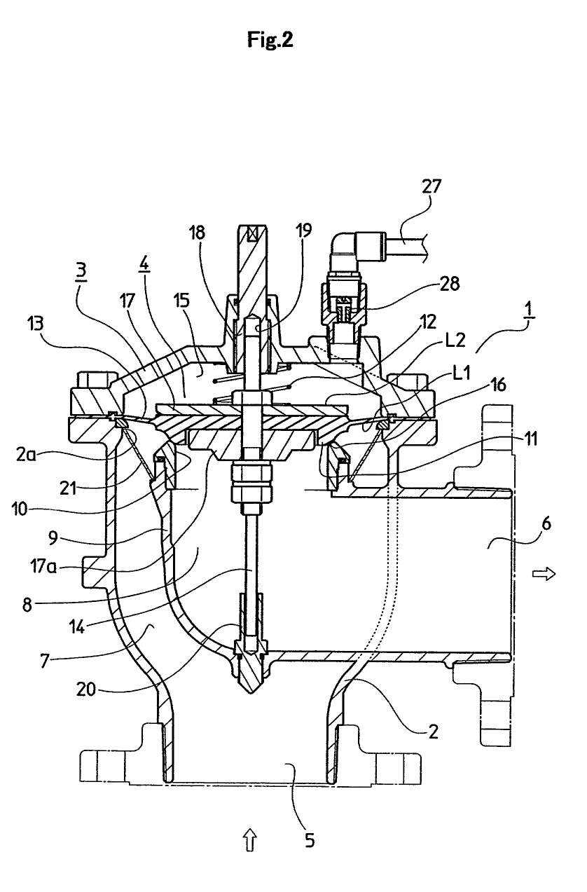

FIG. 3 is an enlarged sectional view showing a bypass flow path.

FIG. 4 shows a conventional water level regulating valve in use.

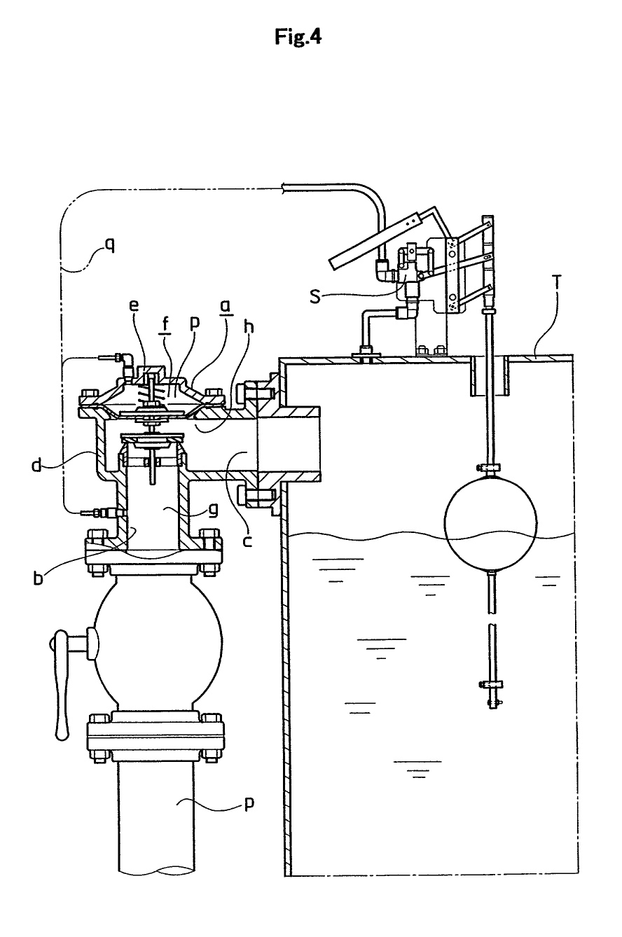

FIG. 5 is a sectional view of the conventional water level regulating valve.

### DETAILED DESCRIPTION OF THE PREFERRED EMBODIMENT

An embodiment of the present invention will be hereinafter described with reference to the attached drawings. Reference character 1 designates a main body of a water level regulating valve disposed to constitute a perpendicular flow path between a water tank T and a water pipe P vertically installed next to the water tank T. The main body 1 is chiefly made up of a valve box 2, a bonnet 3, and a water level regulating mechanism 4.

The valve box 2 has an inlet 5 connected to the water pipe P and an outlet 6 connected to a spout formed in the upper part of a sidewall of the water tank T. The inlet 5 is formed in the lower part of the valve box 2, and the outlet 6 is formed in the side part of the valve box 2 so as to cross the center lines of the inlet 5 and the outlet 6 with each other. A primary pressure chamber 7 and a secondary pressure chamber 8 that lead to the inlet 5 and the outlet 6, respectively, are disposed in the interior of the valve box 2. The secondary pressure chamber 8 and the primary pressure chamber 7 are divided by a partition 9 into an inside and an outside, respectively, in the interior of the valve box 2. An upward valve port 10 is formed in the partition 9 coaxially with the inlet 5, and the primary pressure chamber 7 and the secondary pressure chamber 8 are linked to each other through the valve port 10. An opening 2a that leads to the primary pressure chamber 7 and to the secondary pressure chamber 8 through the valve port 10 is formed in the upper part of the valve box 2.

The water level regulating mechanism 4 is chiefly made up of a valve disc 11 provided to open and close the valve port 10, a spring 12 used to urge the valve disc 11 in a valve-closing direction, a diaphragm 13 coupled to the valve disc 11, and a valve rod 14 of the valve disc 11. A bonnet 3 has a concave space 15 at its inside, and serves as a lid for closing the opening 2a of the valve box 2. The bonnet 3 and the upper part of the valve box 2 are joined to each other through the diaphragm 13. The primary pressure chamber 7 that leads to the opening 2a of the valve box 2 and the internal space 15 of the bonnet 3 on the back side (i.e., upper surface) of the diaphragm 13 are divided by the diaphragm 13, and, as a result, the internal space 15 is defined as a diaphragm chamber 15.

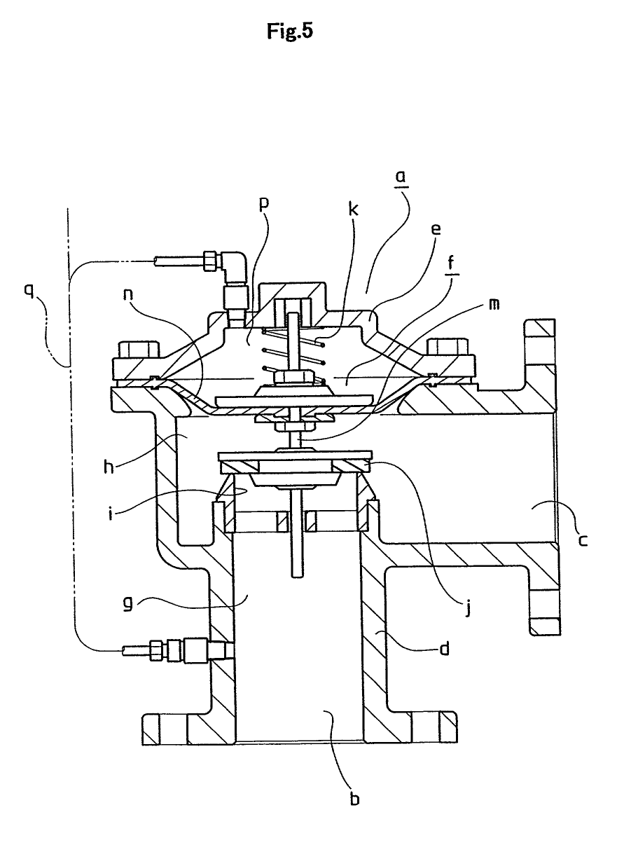

The valve disc 11 is constructed in such a manner to cause the undersurface of the diaphragm 13 to protrude substantially annularly so as to correspond to a valve seat 16 disposed around the valve port 10. Diaphragm pressers 17 and 17a shaped almost like a disk are joined to the undersurface of the diaphragm 13 inside the valve disc 11 and to the upper surface of the diaphragm 13 corresponding to the valve disc 11, respectively. An effective pressure-receiving area L2 of the diaphragm 13 on the side of the diaphragm chamber 15 (i.e., an area of the entire upper surface of the diaphragm 13 including the diaphragm presser 17) is set to be larger than an effective pressure-receiving area L1 of the diaphragm 13 on the side of the primary pressure chamber 7 (i.e., an annular area of the undersurface of the diaphragm 13 outside the valve disc 11). A valve rod 14 is fixed at the center of the valve disc 11 (corresponding to the center of the diaphragm 13) in such a manner as to project from the upper and lower surfaces thereof. The upper end of the valve rod 14 is freely slidably inserted in a valve rod guide 19 formed by hollowing the lower end of an adjusting screw 18 disposed on the upper part of the diaphragm chamber 15. The lower end of the valve rod 14 is freely slidably inserted in a cylindrical valve rod guide 20 that protrudes to the bottom of the secondary pressure chamber 8. The adjusting screw 18 is screwed into the center of the upper part of the bonnet 3 in such a manner as to plunge from the outside. The upper end part of the adjusting screw 18 that projects from the upper part of the bonnet 3 is rotated to move the adjusting screw 18 up and down, and the amount of displacement of the diaphragm 13 is adjusted by bringing the lower end of the adjusting screw 18 into contact with the diaphragm presser 17 or by detaching the lower end thereof from the diaphragm presser 17 when the diaphragm 13 is displaced, and thereby the degree of opening of the valve disc 11, i.e., the amount of water to be spurted is adjusted. The spring 12 through which the valve rod 14 is passed is compressed and interposed between the diaphragm chamber 15 and the diaphragm presser 17, and urges the valve disc 11 in the valve-closing direction. In the primary pressure chamber 7, a strainer 21 is disposed around the valve port 10. In this embodiment, the valve disc 11 is formed integrally with the diaphragm 13 so as to couple the diaphragm 13 to the valve disc 11, and, as a result, the main body 1 is made compact. However, like the water level regulating valve a shown in FIG. 5, the valve disc 11 and the diaphragm 13 can be separated from each other, and the diaphragm 13 can be joined to the valve disc 11 such that the valve disc 11 is connected to the valve rod 14 that projects to the central lower part of the diaphragm 13. If the valve disc 11 and the diaphragm 13, which serve as individual parts, are joined to each other in this way, the valve disc 11 receives primary pressure in the valve-closing direction at its back side (i.e., a surface opposite to the undersurface of the diaphragm 13), as described later, because the primary pressure chamber 7 and the diaphragm chamber 15 are linked to each other. Accordingly, the effective pressure-receiving area L1 of the diaphragm 13 on the side of the primary pressure chamber 7 is calculated by subtraction of the area of the back of the valve disc 11 that receives the primary pressure in the valve-closing direction from the area of the entire undersurface of the diaphragm 13, and therefore the effective area L2 of the diaphragm 13 on the side of the diaphragm chamber 15 that corresponds to the area of the entire upper surface of the diaphragm 13 is set to be greater than the effective pressure-receiving area L1 of the diaphragm 13 on the side of the primary pressure chamber 7.

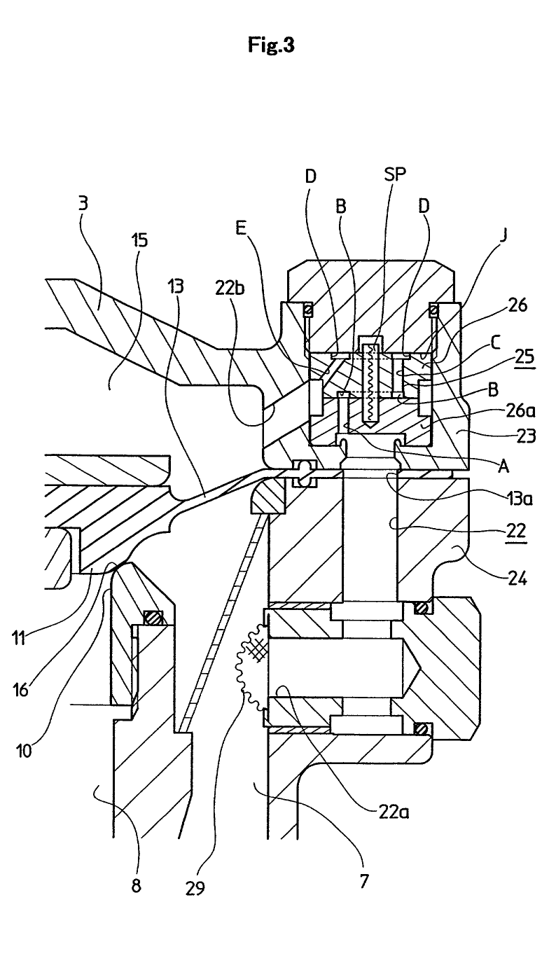

As shown in FIG. 3, the primary pressure chamber 7 and the diaphragm chamber 15 are linked to each other through a bypass flow path 22. The bypass flow path 22 is included in flanges 23 and 24 provided to join the valve box 2 to the bonnet 3. An entrance 22a of the bypass flow path 22 is formed to lead to the primary pressure chamber 7, and an exit 22b thereof is formed to lead to the diaphragm chamber 15. In the bypass flow path 22, a through hole 13a is formed in the outer edge of the diaphragm 13 interposed between the flanges 23 and 24 so as not to stop the flow of water along the bypass flow path 22. As shown in FIG. 3, in the bypass flow path 22, an inflow aperture 25 is disposed at the upstream side in the neighborhood of the exit 22b. The inflow aperture 25 consists of flow paths A to E each of which is extremely thin and long and meanders in the interior of almost disk-shaped block bodies 26 and 26a vertically overlapped with each other. The inflow aperture 25 is constructed as follows. That is, in the lower block body 26a, a first extra-fine vertical flow path A that penetrates in an upward/downward direction is formed in such a way as to lead to the downstream side of the bypass flow path 22. In the upper block body 26, a first extra-fine annular flow path B that leads to the upstream end of the first vertical flow path A is formed in the bottom surface part thereof. In the first annular flow path B, a second extra-fine vertical flow path C that penetrates through the upper block body 26 in the upward/downward direction is consecutively formed in parallel with the first vertical flow path A at a part facing the consecutive part to the upstream end of the first vertical flow path A, and a second extra-fine annular flow path D that leads to the upstream end of the second vertical flow path C is formed at the upper surface of the upper block body 26. In the second annular flow path D, an extra-fine inclined flow path E inclined in such a falling way as to lead to the exit 22b is consecutively formed at a part facing the consecutive part to the upstream end of the second vertical flow path C. In the block bodies 26 and 26a, a spring pin SP is inserted into a center part that is not included in the flow paths A to E, and the bottom surface of the block body 26 and the upper surface of the block body 26a are joined to each other so as to connect the flow paths A and B to each other, and the flow path D is constructed by the upper surface of the upper block body 26 and a joint surface J thereof. The diaphragm chamber 15 also leads to the primary side of the ball tap S serving as a pilot valve, and an outflow aperture 28 larger in the flow path area than the inflow aperture 25 is disposed at the downstream end of a path 27 leading to the ball tap S. The entrance 22a of the bypass flow path 22 is covered with a strainer 29.

The ball tap S includes a valve disc (not shown) by which a primary side and a secondary side are divided from each other in the main body placed on the top plate of the water tank T, and the secondary side is connected to the water tank T. The valve disc is joined to a lever SR freely movable upward and downward in order to open and close the valve disc through a link mechanism SL, and the upper end part of a vertical shaft SV that is freely slidably passed through a float ball SF is pivotally attached to the tip of the lever SR. The upper end of the vertical shaft SV is constructed to reciprocate up and down along the same axis by a pair of parallel links ST, and one of the parallel links ST is provided with a balance weight SW acting in a direction in which the vertical shaft SV is pushed up. The vertical shaft SV plunges into the interior of the water tank T while leaving the upper end side attached to the lever SR. In the plunged part of the vertical shaft SV, a stopper SS and a fall-off stopper SN for the float ball SF are provided at an upper appropriate position and a lower appropriate position, respectively. The stopper SS is positioned to cause a floating state of the float ball SF in contact with the stopper SS to correspond to a water level set in the water tank T. In this state, the float ball SF pushes up the vertical shaft SV through the stopper SS, and also pushes up the lever SR so as to maintain the closed state of the valve disc. In this state, the balance weight SW supports the lifting force of the vertical shaft SV by the float ball SF. When the water level of the water tank T is changed from the above-mentioned set value below a predetermined range, i.e., when the float ball SF is downwardly separated from the stopper SS by a predetermined distance, the vertical shaft SV, which has been in a lifted state by the buoyancy of the float ball SF and the balance weight SW, falls, and the lever SR downwardly swings so as to open the valve disc. As a result, the primary side and the secondary side of the ball tap S are linked to each other, and the pressured water in the diaphragm chamber 15 of the main body 1 is spurted to the water tank T. The ball tap S is not limited to the above-mentioned structure. In brief, what is required of the ball tap serving as a pilot valve of the water level regulating valve is to open and close the valve in accordance with a change in the water level of the water tank T.

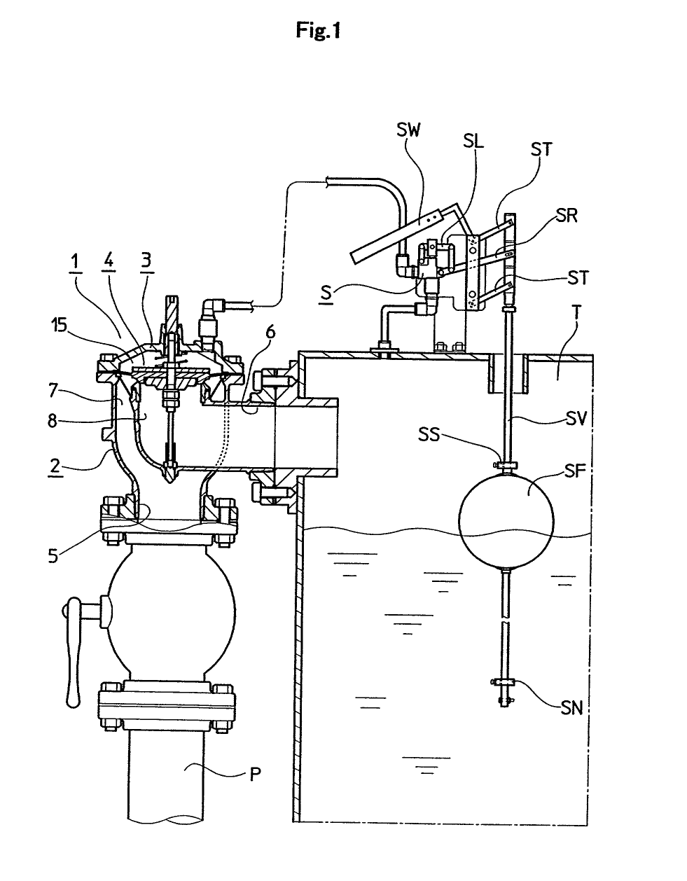

Next, the operation of the water level regulating valve according to the present invention will be described. In the state of FIG. 1 in which storage water in the water tank T keeps a predetermined water level, the ball tap S is closed, and the main body 1 of the water level regulating valve is in a feedwater-stopped state. In this feedwater-stopped state, the primary pressure is applied onto the primary pressure chamber 7 and the diaphragm chamber 15 that are divided by the diaphragm 13, and therefore the same pressure is applied onto both of the pressure receiving surfaces of the diaphragm 13. The valve disc 11 receives the valve-closing force resulting from a difference in the received pressure caused by the fact that the effective pressure-receiving area L2 of the diaphragm 13 on the side of the diaphragm chamber 15 is larger than the effective pressure-receiving area L1 of the diaphragm 13 on the side of the primary pressure chamber 7 and the elastic force of the spring 12 in the valve-closing direction, thus keeping the valve-closing state. Thereafter, when the water level in the water tank T moves below a set water level within a predetermined range, the ball tap S is opened, and the primary side and the secondary side of the ball tap S are linked to each other. Accordingly, the pressured water in the diaphragm chamber 15 is spurted to the water tank T through the ball tap S. As a result, the pressure of the diaphragm chamber 15 falls, and moves below the pressure of the primary pressure chamber 7. Therefore, the pressure of the primary pressure chamber 7 opens the valve disc 11 against the pressure of the diaphragm chamber 15 and against the elastic force of the spring 12, and water is supplied to the water tank T. Thereafter, when the water level of the water tank T reaches the set value, the ball tap S is closed, and the water flow from the diaphragm chamber 15 to the ball tap S is stopped. The diaphragm chamber 15 becomes identical in pressure with the primary pressure chamber 7 because of water flow from the primary pressure chamber 7 to the diaphragm chamber 15 through the bypass flow path 22, and the valve disc 11 is closed, and the water supply to the water tank T is stopped. When the pressured water in the diaphragm chamber 15 is conveyed to the ball tap S, the diaphragm chamber 15 receives water from the primary pressure chamber 7 through the bypass flow path 22. This water flow moderates the flow to the diaphragm chamber 15 because the inflow aperture 25 disposed at the upstream side of the bypass flow path 22 reduces the sectional area of the flow and increases pressure loss. On the other hand, also in the water flow from the diaphragm chamber 15 to the ball tap S, the outflow aperture 28 moderates the flow. Since the flow path sectional area of the outflow aperture 28 is larger than that of the inflow aperture 25, the amount of outflow to the ball tap S becomes greater than the amount of inflow to the diaphragm chamber 15, and the pressure in the diaphragm chamber 15 falls, thus moving the diaphragm 13 in the valve-closing direction.

According to the present invention, the inlet 5 is disposed at the lower part of the main body 1 of the water level regulating valve, and is connected to the vertical water pipe P. Additionally, the outlet 6 is disposed at the side part of the main body, and is connected to the water tank T. Therefore, the main body 1 can be installed in such a way as to construct a perpendicular flow path between the vertical water pipe P and the water tank T.

Further, the primary pressure chamber 7 and the secondary pressure chamber 8 formed by dividing the interior of the main body 1 are linked to each other through the valve port 10 upwardly formed coaxially with the inlet 5 so as to lead to the inlet 5 and the outlet 6, respectively, and the valve disc 11 is provided to open and close the valve port 10. Therefore, the valve port 10 can be disposed on the same axis with the vertical water pipe P, and the valve disc 11 used to open and close the valve port 10, the diaphragm 13 to drive the valve disc 11 and the spring 12 can be disposed on the upper part of the main body 1. Therefore, when compared with, for example, a structure in which a series of mechanisms, such as a valve port and a valve disc, are provided to the side part of the main body, maintenance of the main body 1 can be carried out in a more comfortable position, and the work can be more efficiently carried out.

Further, the valve disc 11 is urged in the valve-closing direction by the spring 12, and the diaphragm 13 coupled to the valve disc 11 divides the diaphragm chamber 15 disposed on the back side of the diaphragm 13 in the interior of the main body from the primary pressure chamber 7. Additionally, the effective pressure-receiving area L2 of the diaphragm 13 on the side of the diaphragm chamber 15 is set larger than the effective pressure-receiving area L1 of the diaphragm 13 on the side of the primary pressure chamber 7, and the primary pressure chamber 7 and the diaphragm chamber 15 are linked to each other through the bypass flow path 22. Therefore, in the feedwater-stopped state of the main body 1, the primary pressure is applied onto the diaphragm chamber 15 and the primary pressure chamber 7 that are divided by the diaphragm 13, and the valve disc 11 is closed by the valve-closing force resulting from the difference between the effective pressure-receiving areas L1 and L2 of the diaphragm 13 on the side of the primary pressure chamber 7 and on the side of the diaphragm chamber 15 and by the elastic force of the spring 12 in the valve-closing direction. Therefore, both the pressure receiving surfaces of the diaphragm 13 can be supported by the same pressure, and the possibility that the valve will be broken can be reduced by reducing a load applied onto the diaphragm 13. Therefore, the water level regulating valve of the present invention can remove defects resulting from the structure in which pressure is applied only onto one side of the diaphragm n on the side of the diaphragm chamber p in the feedwater-stopped state like a conventional water level regulating valve a i.e., the defect of thickening the diaphragm n and enlarging the main body of the water level regulating valve a in order to extremely enlarge the pressure receiving diameter. Additionally, since a flexible operation can be performed even if the diaphragm 13 having a normal thickness and a normal pressure-receiving diameter is used, it is possible to provide the main body 1 of the water level regulating valve that has a size sufficient to correspond to a rated flow. Further, since the diaphragm chamber 15 that leads to the primary pressure chamber 7 through the bypass flow path 22 is linked to the primary side of the ball tap S serving as a pilot valve, the pressured water in the diaphragm chamber 15 flows to the ball tap S when the ball tap S is opened, and the pressure in the diaphragm chamber 15 moves lower than that in the primary pressure chamber 7. Accordingly, the pressure in the primary pressure chamber 7 can open the valve disc 11 against the pressure of the diaphragm chamber 15 and against the elastic force of the spring 12, and water can be automatically supplied to the water tank T.

Further, since the inflow aperture 25 and the outflow aperture 28 are disposed at the bypass flow path 22 and at the path 27 leading to the ball tap S, respectively, the flow of water from the primary pressure chamber 7 to the diaphragm chamber 15 through the bypass flow path 22 and the flow of water from the diaphragm chamber 15 to the ball tap S can be controlled and moderated when the ball tap S is opened. Additionally, since the outflow aperture 28 is set to be larger than the inflow aperture 25 in the sectional area of the flow path, the diaphragm 13 and the valve disc 11 can be displaced so as not to cause rapid pressure fluctuations in the diaphragm chamber 15. Therefore, a load occurring in the diaphragm 13 that is violently moved up and down in response to rapid pressure fluctuations of the diaphragm chamber 15 or harsh noises produced by the diaphragm 13 at this time can be significantly reduced. Additionally, a water hammer occurring in the water pipe side when the ball tap S is closed can also be prevented. Accordingly, the practical effect thereof is unquestionably great.

What is claimed is:

1. A water level regulating valve comprising:
a main body;
an inlet disposed at a lower part of the main body;
an outlet disposed at a side part of the main body;
a primary pressure chamber and a secondary pressure chamber formed by dividing an interior of the main body so as to lead to the inlet and the outlet, respectively, the primary pressure chamber and the secondary pressure chamber being linked to each other through a valve port upwardly formed coaxially with the inlet;
a valve disc disposed to open and close the valve port, the valve disc being urged in a valve-closing direction by a spring; and
a diaphragm coupled to the valve disc, a diaphragm chamber disposed on a back side of the diaphragm in the interior of the main body and the primary pressure chamber being divided by the diaphragm;
wherein an effective pressure-receiving area of the diaphragm on a side of the diaphragm chamber is set greater than an effective pressure-receiving area of the diaphragm on a side of the primary pressure chamber, and the primary pressure chamber and the diaphragm chamber are linked to each other through a bypass flow path, and the diaphragm chamber is linked to a primary side of a ball tap serving as a pilot valve.

2. The water level regulating valve as recited in claim 1, further comprising an inflow aperture and an outflow aperture disposed at the bypass flow path and a path leading to the ball tap, respectively, wherein the outflow aperture has a larger flow path area than the inflow aperture.
